(19) United States
(12) Patent Application Publication
(10) Pub. No.: US 2012/0167759 A1
(43) Pub. Date: Jul. 5, 2012

(54) Short Length Pump Having Brine Resistant Seal and Rotating Wrist Pin and Related Methods

(75) Inventors: Gromicho Chinthan, Karnataka (IN); Mark Dille, Fort Worth, TX (US)

(73) Assignee: SPM FLOW CONTROL, INC., Fort Worth, TX (US)

(21) Appl. No.: 13/339,640

(22) Filed: Dec. 29, 2011

Related U.S. Application Data
(60) Provisional application No. 61/427,850, filed on Dec. 29, 2010.

(51) Int. Cl. F16J 1/00

(52) U.S. Cl. 92/172

(57) ABSTRACT

Pumps and plunger assemblies are provided. An exemplary pump can have or contain a cylinder mounted in a pump housing, a plunger assembly including a crosshead, a plunger, a stationary bushing having substantial portions fixedly mounted within a laterally extending bore of the crosshead, and a non-stationary pivotally rotating wrist pin mounted within the bushing. The pump can also include a power end seal assembly including a seal housing extending at least partially through an aperture in the sealed fluid end-facing side of the power end of the pump, a power end seal disposed therein in sealing contact with the power end section of the plunger and a splashguard assembly.

### RELATED APPLICATIONS

This application claims the benefit of and priority to U.S. Provisional Patent Application No. 61/427,850, titled “Short Length Pump Having Brine Resistant Seal and Rotating Wrist Pin and Related Methods,” filed on Dec. 29, 2010, incorporated herein by reference in its entirety.

### TECHNICAL FIELD

This disclosure relates to pumps in general, and short-length pumps in particular.

### BACKGROUND OF THE DISCLOSURE

Oil and gas wells require servicing such as cementing, gravel packing, and acidizing. All of these services require pumps for pumping fluid down the well. The type of pump used normally for these applications is a reciprocating or positive displacement pump. The pump typically has a crankshaft mounted in a housing and positioned to drive a plunger. The plunger has or otherwise connects to a crosshead that is reciprocally carried within a cylinder in the housing, which reciprocates perpendicular to the crankshaft. A connecting rod connects the crankshaft to the plunger via the crosshead.

The plunger typically extends through a wall of a power section and into a wall of a manifold section. A fluid seal contained within the manifold section surrounds the plunger to prevent or limit fluid leakage inside the pump housing. A power seal contained within or otherwise carried by the wall of the power section surrounds the plunger to prevent or limit fluid incursions into the power section. As the power seal is often subject to severe degradation, various attempts have been made to reduce fluid incursions. These include utilization of a multi-diameter piston whereby the end of the piston entering the power section is larger than the piston diameter of the portion of the piston entering the output manifold section.

A typical pump will be a triplex type having three cylinders, three plunger assemblies, and three connecting rods connecting the crankshaft to the respective plungers. Normally the axis of rotation of the crankshaft will be intersected by the axis of the cylinders. A diesel engine or other prime mover will connect to a gear train for rotating the crankshaft. An example of this type of well service pump (e.g., plunger pump) is disclosed in U.S. Pat. No. 2,766,701 to Giraudeau.

Often these pumps will be mounted on a trailer or a skid, back-to-back. Each pump has an outboard side connected to a manifold with valves for drawing in and pumping fluid acted on by the plunger. The inboard sides will be located next to each other. A separate prime mover or engine will be connected to each of the pumps. The overall width from the one manifold to the other manifold typically does not exceed roadway requirements if the pumps are to be trailer mounted, in the United States this being about 8½ feet (e.g., 102 inches). To meet these width requirements, some have reduced the size of the pump, for example reducing the pump stroke from six inches to four inches.

Recognized by the inventor, therefore, is the need and improved pump design which provides an optimal pump stroke and which allows for the use of uniform diameter pump plungers.

### SUMMARY

In a first aspect, embodiments are disclosed of a pump having a cylinder mounted in a pump housing, a plunger assembly including a crosshead reciprocally or otherwise slidably disposed in the cylinder, a bore extending laterally to a longitudinal axis of the cylinder, a plunger having a power end section connected to the crosshead, a stationary bushing having substantial portions fixedly mounted within the bore of the crosshead, and a non-stationary wrist pin mounted within the bushing.

In certain embodiments, the pump also includes a crankshaft rotatably mounted in the housing and a connecting rod having a crankshaft end connected to the crankshaft and a crosshead end connected to the wrist pin, whereby the wristpin is pivotally rotatably mounted to the crosshead and fixedly connected to the crosshead end of the connecting rod to provide pivotal rotation when the connecting rod strokes.

In certain embodiments, the crosshead end of the connecting rod has a flanged end including an arcuate portion having an inner surface radius that at least substantially matches an outer surface radius of the wrist pin. In certain embodiments, the arcuate portion of the flanged end extends from about 100 angle degrees to about 150 angle degrees. In certain embodiments, the wristpin includes a set of fastener bores, and the flanged end includes a set of fastener apertures and corresponding set of fasteners extending through the fastener apertures and into a corresponding set of the fastener bores extending into the wrist pin to fixedly connect the crosshead end of the connecting rod to the wrist pin.

In certain embodiments, the crosshead includes an open slot portion extending from a crankshaft-facing end and along the longitudinal axis of the crosshead to join with the laterally-extending bore, and a crankshaft-facing recessed surface portion positioned at a base of the open slot portion. In such embodiments, the pump can also include a bushing assembly including the bushing, described above, and at least one retaining plate separate from or integral with the bushing. The retaining plate is correspondingly mounted to the crankshaft-facing recessed surface portion to mount the bushing within the bore of the crosshead and to prevent rotation thereof. In certain embodiments, the crankshaft-facing surface portion is oriented at least substantially perpendicular to the longitudinal axis of the crosshead such that a surface plane of the crankshaft-facing recessed surface portion extends approximately through the center of the wrist pin when the wrist pin is positioned within the laterally-oriented bore.

In certain embodiments, the bushing is in the form of a single arcuate-shaped bushing shaped to extend for at least approximately 180 angle degrees to conform to a corresponding outer surface portion of the wrist pin and a corresponding inner surface portion of the laterally-oriented bore of the crosshead. In other certain embodiments, the bushing is at least partially cylindrically shaped and extends circumferentially for an amount greater than 180 angle degrees to provide for retaining the wristpin within the bushing and the laterally oriented bore, and is substantially less than 360 angle degrees to accommodate for pivotal rotation of the connecting rod resulting from rotation of the crankshaft end of the connecting rod about the crankshaft axis.

In certain embodiments, the pump includes a power end having a sealed fluid end-facing side and a power end seal assembly adjacent an aperture extending through the sealed fluid end-facing side. The power end seal assembly can include a power end seal housing extending at least partially through the aperture, and a power end seal positioned within the power end seal housing in sealing contact with the power end section of the plunger. In certain embodiments, the power end seal is positioned within the power end seal housing at a location within confines of the power end. In certain embodiments, the power end seal assembly further comprises a splash guard positioned at least partially within the power end seal housing to deflect fluids escaping the output manifold through the fluid seal.

In certain embodiments, the power end seal assembly further includes a splashguard having an elongate cylindrical section positioned at least substantially within the power end seal housing to deflect fluids escaping an output manifold of the pump through an output manifold fluid seal. In certain embodiments, the power end facing surface of the elongate cylindrical section of the splash guard is positioned in contact with a corresponding fluid end facing surface of the power end seal. In certain embodiments, the cylindrical section of the splash guard is further positioned in contact with an inner surface of the power seal housing, an outer surface of the plunger, and a fluid end-facing face of the power end seal. In certain embodiments, the cylindrical section of the splash guard extends at least partially through the aperture of the sealed fluid end-facing side of the power end. In certain embodiments, a conical shaped the lip section is connected to or integral with the cylindrical section of the splashguard to further help deflect fluids leaking from the fluid end section of the pump.

In certain embodiments, the pump includes a fluid end, a power end having a sealed fluid end-facing side, an annular extension extending toward the fluid end, and a power end seal assembly adjacent the aperture of the sealed fluid end-facing side and including a power end seal housing. The power end seal housing can have an inwardly extending flange, an outwardly extending flange connected to the annular extension, and an elongate main body extending therebetween. In certain embodiments, the power and seal assembly further includes an annular power end fluid seal positioned in contact with a fluid end-facing portion of the inward extending flange, an inner surface of the power seal housing, an outer surface of the plunger, and a power end-facing face of an elongate cylindrical section of a splash guard. In certain embodiments, the power and seal assembly also or alternatively includes a splashguard assembly positioned to help deflect fluid escaping from the fluid section of the pump. The splashguard assembly can include the splashguard and an annular retention plate operable or otherwise configured to urge the cylindrical section of the splashguard into contact with the power end seal which urges the power end seal into contact with the inwardly extending flange. In certain embodiments, the housing further includes and inwardly extending annular stub located adjacent the outwardly extending flange. In certain embodiments, the elongate cylindrical section of the splashguard correspondingly includes an annular recess aligned/alignable with the annular stub so that the annular stub functions to facilitate retaining the cylindrical section of the splashguard within the power end seal housing.

In a second aspect, embodiments are disclosed of a pump having a power end, a fluid end, and a stroke length a stroke length. The pump can include a housing having an entrance, a cylinder mounted in the housing, a plunger assembly including a crosshead reciprocally or otherwise slidably disposed in the cylinder and having a bore extending laterally to the cylinder axis, a plunger including a power end section connected to the crosshead and a fluid end section extending through a fluid seal in an output manifold, a bushing having substantial portions fixedly mounted within the bore of the crosshead, and a wrist pin pivotally rotatably mounted within the bushing. The pump can also include a crankshaft rotatably mounted in the housing, a connecting rod having a crankshaft end connected to the crankshaft and having a crosshead end connected to the wrist pin such that the wrist pin is pivotally rotatably mounted to the crosshead and fixedly connected to the crosshead end of the connecting rod to provide pivotal rotation when the connecting rod strokes. The pump can also include a power end seal assembly adjacent the entrance to the cylinder. The power end seal assembly can include a power end seal housing, a power end seal located within the housing and positioned so that the power end seal is in sealing contact with the power end section of the plunger, and a splash guard positioned at least partially within the power end seal housing to deflect fluids escaping the output manifold of the fluid section of the pump through the fluid seal.

In a third aspect, disclosed are embodiments of a plunger assembly. The plunger assembly can include a crosshead operable to be reciprocally or otherwise slidably disposed in a cylinder of a plunger (e.g. reciprocating) pump, a plunger having a fluid end section and having a power end section connected to the crosshead, a bushing having substantial portions fixedly mounted within a laterally extending bore of the crosshead, and a wrist pin pivotally rotatably mounted within the bushing. In certain embodiments, the wrist pin includes a set of fastener recesses extending therein and positioned to receive a corresponding set of fasteners to fixedly connect a crosshead end of a connecting rod to the wrist pin. In certain embodiments, the crosshead includes an open slot portion extending from a crankshaft-facing end along the longitudinal axis of the crosshead to join with the laterally-extending bore, and a crankshaft-facing recessed surface portion positioned at a base of the open slot portion. In such embodiments, the plunger assembly can further include a bushing assembly including the bushing and at least one retaining plate separate from or integral with the bushing. The retaining plate can be connected to the crankshaft-facing recessed surface portion to mount the bushing within the laterally extending bore of the crosshead and to prevent rotation thereof. In certain embodiments, the crankshaft-facing surface portion is oriented at least substantially perpendicular to the longitudinal axis of the crosshead such that a surface plane of the crankshaft-facing recessed surface portion extends approximately through the center of the wrist pin when the wrist pin is positioned within the laterally-oriented bore.

In certain embodiments, the bushing is in the form of a single arcuate-shaped bushing that is shaped to extend for at least approximately 180 angle degrees to conform to a corresponding outer surface portion of the wrist pin and to conform to a corresponding inner surface portion of the laterally-oriented bore of the crosshead. According to certain alternative embodiments, the bushing is at least partially cylindrically shaped and extends circumferentially for an amount greater than 180 angle degrees to provide retention thereof and extends substantially less than 360 angle degrees to accommodate for pivotal rotation of a connecting rod when connected thereto resulting from rotation of a crankshaft end of the connecting rod about a crankshaft axis.

Other aspects, features, and advantages will become apparent from the following detailed description when taken in conjunction with the accompanying drawings, which are a part of this disclosure and which illustrate, by way of example, principles of the inventions disclosed.

### DESCRIPTION OF THE FIGURES

The accompanying drawings facilitate an understanding of the various embodiments. It is to be noted, however, that the drawings illustrate only various embodiments and are therefore not to be considered limiting of the invention's scope as it may include other effective embodiments as well.

FIG. 1 is a schematic view of a pair of compact pumps mounted in a back-to-back assembly according to an embodiment of the present invention;

FIG. 2 is a sectional view of a prior art well service pump;

FIG. 3 is a sectional view of a pump according to an embodiment of the present invention;

FIG. 4A is a sectional view of a pump according to an embodiment of the present invention with the plunger in a suction stroke;

FIG. 4B is a sectional view of a pump according to an embodiment of the present invention with the plunger in a power stroke;

FIG. 5 is a sectional view of a bushing assembly according to an embodiment of the present invention; and

FIG. 6 is a sectional view of a power end seal assembly according to an embodiment of the present invention.

### DETAILED DESCRIPTION

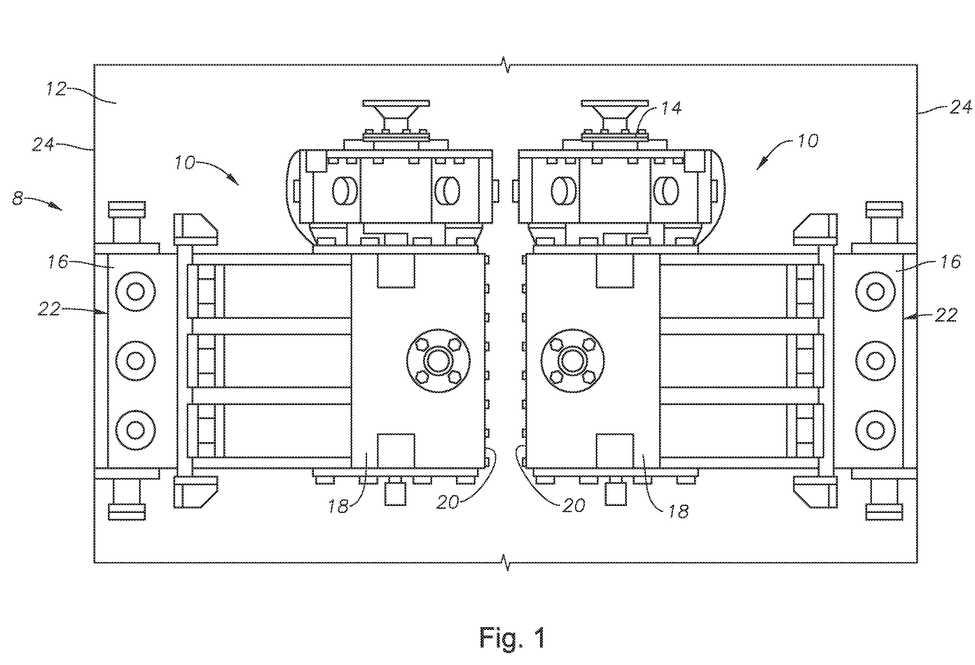

FIG. 1 is a plan view of a pair of pumps according to one or more aspects of the present disclosure. Specifically, FIG. 1 depicts a pair of pumps 10 (e.g., plunger pump, well service pump) mounted in a back-to-back application. The pumps 10 are typically identical pumps although they may be inverted relative to one another. The pumps 10 may be mounted on a platform 12 (e.g., skid, truck bed, trailer, etc.) together with a prime mover to provide a portable self-contained pumping unit. Depicted in FIG. 1, the skid 12 is a trailer adapted for connecting with a tractor (e.g., truck). The prime mover may be an electric motor or an internal combustion engine, for example. The output of the prime mover is connected to a gear reducer 14. The pumps 10 are depicted as triplex pumps in the depicted embodiment, however, it will be recognized by those skilled in the art with the benefit of the present disclosure that the pumps 10 may comprise more or fewer plungers.

According to an embodiment, the pumps 10 are compact in size so as to permit the two pumps to be oriented in a back-to-back assembly 8 and to legally travel on United States roadways. For example, government regulations often provide vehicle width restrictions. In the depicted example, the width restriction, denoted by “WR”, is the same or smaller as the width of the platform 12 and is described as 8.5 feet or 102 inches in this embodiment.

The back-to-back pump assembly 8 has an end-to-end length limitation (i.e., from outboard end 22 of the left pump 10 to the outboard end 22 of the right pump 10) of less than 102 inches, in this example. Typically, the length of the back-to-back pump assembly 8 is about 101.5 inches.

The back-to-back illustration further provides for the opportunity to describe one or more aspects that facilitate achieving a compact plunger pump. It will be apparent, however, to those skilled in the art with benefit of the present disclosure, that embodiments of the pump 10 and various aspects of the pump 10 are not limited to back-to-back assemblies or to providing a compact plunger pump.

The pump 10 can include an output manifold 16 (e.g., fluid end) and a power end 18. In the back-to-back assembly 8, each pump can include an inboard end 20 and an outboard end 22. In the depicted embodiment, the inboard end 20 is the terminal end of the power end 18, and the outboard end 22 is the terminal end, or edge, of the output manifold 16. In the depicted embodiment, the outboard manifolds 16 are disposed at the outside lateral edge 24 of the platform 12 to facilitate easy access to the manifolds for connection of hoses and the like. The pump 10 is described generally relative to back-to-back assemblies for purposes of describing a common utilization of well service pumps.

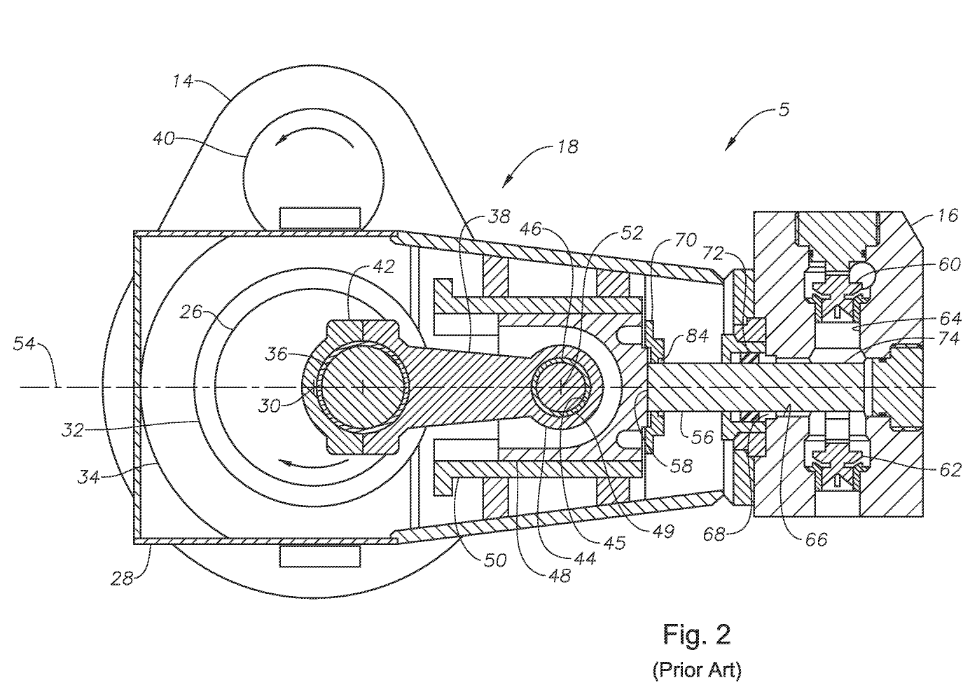

FIG. 2 illustrates a prior art design of a well service plunger pump denoted by the numeral 5. The pump 5 is depicted positioned proximate to bottom dead center. The pump 5 may have a zero offset wherein the cylinder axis 54 (e.g., axis of reciprocation), crankshaft axis 30 and wrist pin axis 52 may be aligned. Alternatively, it may have a positive or negative offset. The pump 5 includes a crankshaft 26 rotatably mounted in a housing 28. The crankshaft 26 has a crankshaft axis 30 about which the crankshaft 26 rotates. The crankshaft 26 is mounted in a housing 28 with bearings 32. The bearings 32 are supported on bearing carriers 34 that are stationary interior parts of the housing 28. The crankshaft 26 has a journal 36 which is a shaft portion to which a connecting rod 38 is attached. A gear train 40 (shown schematically) rotates the crankshaft 26. The connecting rod 38 has a crankshaft end 42 rotatably mounted (e.g., secured) to the journal 36. The connecting rod 38 has an opposite or crosshead end 44 that rotatably mounts to a wrist pin 46 of a crosshead 48, which is surrounded by a bushing 49 within a bore 45 extending through the crosshead end 44. The crosshead 48 reciprocates within a cylinder 50 that is mounted in the housing 28. The wrist pin 46 has a wrist pin axis 52 that is perpendicular to and located on (e.g., co-planar) the cylinder axis 54 (e.g., axis of reciprocation) in the depicted embodiment.

The output manifold 16 comprises a suction valve 62 and a discharge valve 60 in fluid communication through a first bore 64 (e.g., vertical bore). The first bore 64 is intersected by a crossbore 66 having a port 68. The plunger 56, having a stroke of typically at least approximately six inches, reciprocates along cylinder axis 54 through a power end seal 70 and a fluid end seal 72. The power end seal 70 is mounted within the housing 28, adjacent to the entrance port 84 of the cylinder 50, and the fluid end seal 72 is located at the port 68. The plunger 56 has an elongated shared sealing surface 74, also referred to as a wetted region 74. The shared sealing surface 74 contacts and extends through both the power end seal 70 and the fluid end seal 72. The sealing surface 74 typically includes a hard, smooth surface which may have a material (e.g., coating) mounted or applied to the plunger 56 to provide a better mating surface with the seals 70, 72.

Over time, it is common for the surface 74 of the plunger 56 to deteriorate and degrade the seal 70 and/or deteriorate and degrade the seal 72, resulting in brine or other fluids from the fluid end 16 (collectively pumpage) being introduced into the power end 18. Due to the total end-to-end transport length size requirement of typically less than 51 inches, there has been only a limited ability to provide a sufficient seal arrangement to prevent intrusion into power end 18 of the pumpage that escapes fluid end seal 72.

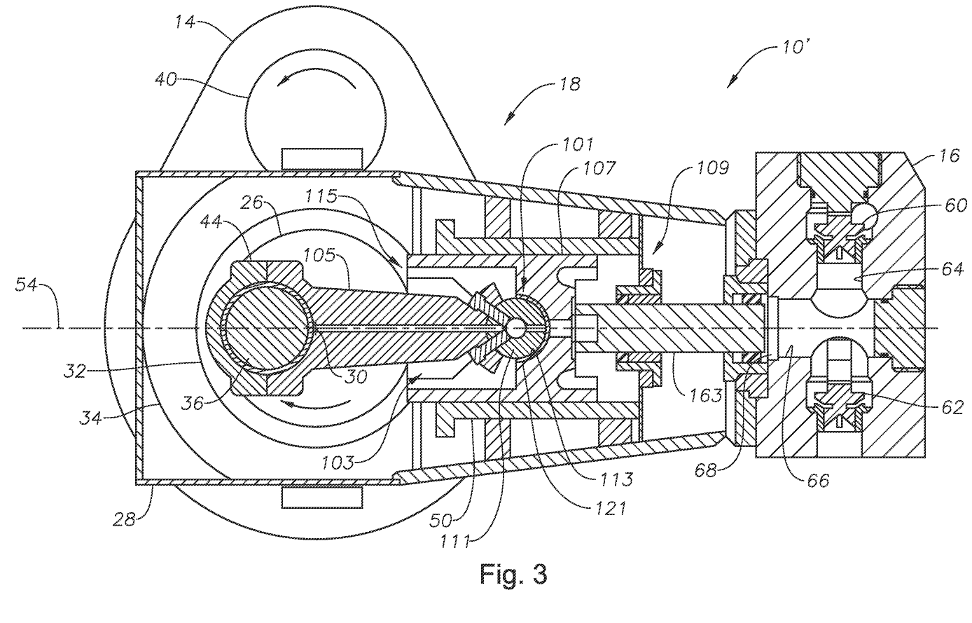

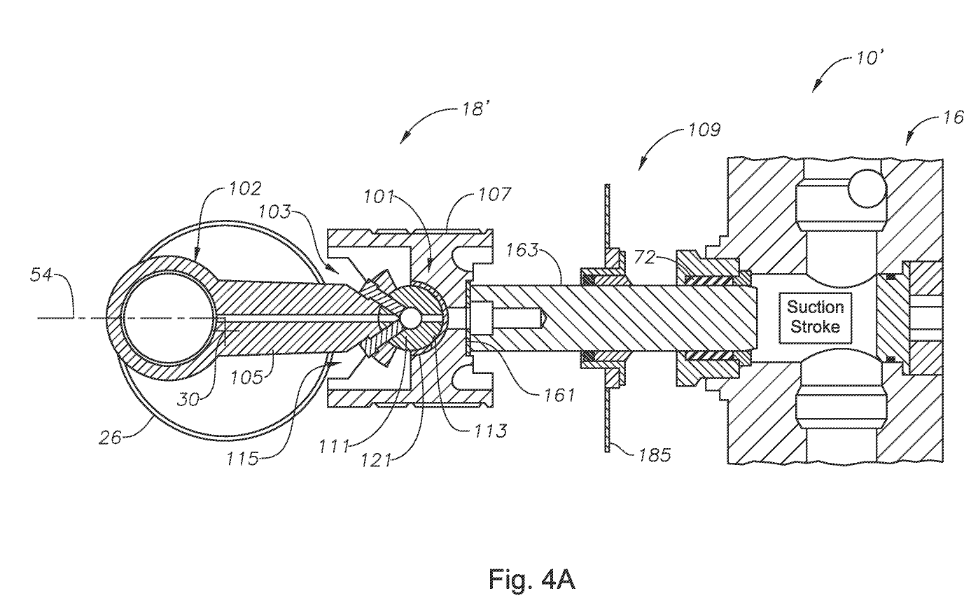

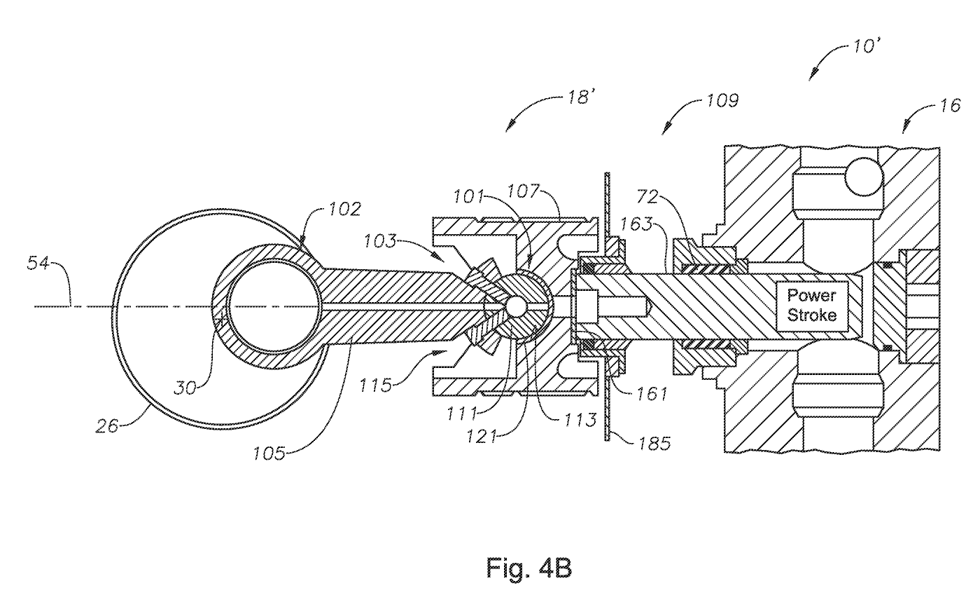

FIGS. 3 and 4A-4B illustrate alternative embodiments of the bushing assembly shown at 101; the configuration of the crosshead end 103 of the connecting rod 105; the internal configuration of the crosshead 107; and the power seal assembly, shown at 109. Specifically, as shown in FIG. 3, in order to provide additional longitudinal space along the cylinder axis 54 of the pump 10′, the crosshead end 103 of the connecting rod 105 has been modified to connect directly to a non-stationary (rotatable) wrist pin 111. Beneficially, such connection allows the wrist pin 111 to pivotally rotate within the bushing 121 within the bore 113 as the connecting rod 105 strokes forward or backward, as is described in more detail below.

According to the illustrated configuration, the crosshead 107 includes a bore 113 extending laterally therethrough and an open slot portion 115 extending from the end adjacent the crankshaft 26 inward to join with the bore 113 to accommodate the crosshead end 103 and the elongate body of the connecting rod 105. The bushing 121 of the bushing assembly 101 lands and is fixed within portions of the inner diameter of the bore 113. The bushing 121 can be in the form of a single arcuate-shaped bushing shaped to extend for at least approximately 180 degrees to conform to the outer surface of the wrist pin 111 and the inner surface of adjacent portions of the bore 113. The bushing 121, which can be at least partially cylindrically shaped to match the shape of the outer surface of wrist pin 111, normally covers less than 360 angle degrees of the outer surface of the wrist pin 111 to provide sufficient room to receive portions of the crosshead end 103.

Alternatively, the bushing 121 can have three separate sections (not shown), with the first section positioned within a first portion of the bore 113 adjacent the open slot portion 115, the second section positioned within a second portion of the bore 113 on the opposite side of the open slot portion 115, and the third section positioned within the portion of the bore 113 joining with the open slot portions 115.

In another alternative embodiment (not shown), the bushing extends beyond 180°, up to 360 angle degrees around the wrist pin 111. In such configuration, the bushing includes attachment points or surfaces to connect within the bore 113 to prevent rotation, and includes a slot or other means of receiving portions of the crosshead end 103 of the connecting rod 105 to allow free movement of the crosshead end 103 and the wrist pin 111 within the bushing 121. Other configurations are, however, within the scope of the present invention.

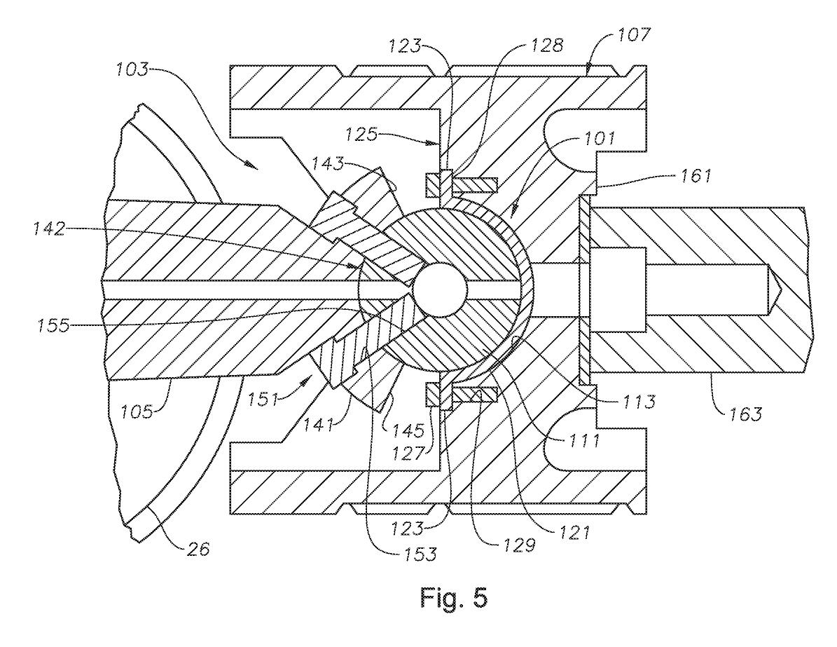

As shown in FIG. 5, the bushing assembly 101 can also include a pair of retaining plates 123 positioned to connect to the recessed portion 125 of the crosshead 107 that is facing the crankshaft 26. A set of fasteners, e.g., bolts 127, extend through a corresponding set of bolt apertures or holes 128 in the retaining plates 123 and into a corresponding set of bolt threaded bores or holes 129 which extend at least partially into a body of crosshead 107. Note, the bolt holes 129 can include threads to facilitate connection thereto. Note also, in another embodiment, the retaining plates 123 can be integral with portions of the bushing 121 to form a pair of connecting anti-rotation flanges. Regardless, the retaining plates 123 or flanges can function to prevent rotation of the bushing 121 within the bore 113. An embodiment provides that the retaining plate 123 is at least one plate, two plates, three plates, four plates, or more.

As still further shown in FIG. 5, the crosshead end 103 of the connecting rod 105 is fixedly connected to the wrist pin 111 so that the wrist pin 111 rotates within the bore 113 to the extent necessary to rotate with the rotational movement of the crosshead end 103 of the connecting rod 105. That is, rather than rotate about the outer surface of a stationary wrist pin 46 as shown, for example, in FIG. 2, the wrist pin 111 is adapted to rotate within the bushing 121 within the bore 113 within the crosshead 107 as the rod 105 strokes, as shown, for example, in FIG. 3. Specifically, according to the exemplary configuration, the wrist pin 111 rotates within the bushing 121 which is fixed within the bore 113 of the crosshead 107.

According to the illustrated configuration, the crosshead end 103 includes a flanged end 141 having an arcuate portion 142 having an inner surface radius that matches the outer surface radius of the wrist pin 111. According to the illustrated configuration, the flanged end 141 extends approximately 130 degrees between the outer surfaces 143, 145. This provides for approximately 20-25 angle degrees of pivotal rotation in either direction to coincide with rotation of the crankshaft end 102 about the crankshaft axis 30 (see FIGS. 4A-4B). Other sizes to accommodate rotation of the connecting rod 105 are possible such as, but not limited to, the flanged end 141 extending from about 100 angle degrees to about 150 angle degrees, from about 110 angle degrees to about 140 angle degrees, or from about 120 angle degrees to about 135 angle degrees. A set of fasteners 151 extend through a corresponding set of fastener apertures or holes 153 and connect within a corresponding set of bores/bolt holes 155 (typically two) extending into wrist pin 111 to fixedly connect the crosshead end 103 of the connecting rod 105 to the wrist pin 111. In the exemplary configuration, the bores/bolt holes 155 are threaded to enhance connection to the fasteners 151.

Beneficially, not only do the alternative embodiments of the bushing assembly 101, the configuration or configurations of the crosshead end 103 of the connecting rod 105, and the internal configuration or configurations of the crosshead 107, both collectively and individually, provide improved performance and easier maintenance, the design improvements also allow the bore 113 of crosshead 107 to be closer to the fluid-facing end 161 of the crosshead 107. Such alternative embodiments can also facilitate improvements in the design of the power seal assembly 109, which can provide sufficient sealing capability on plungers having, for example, a uniform or at least substantially uniform outer diameter such as, e.g., the plunger 163.

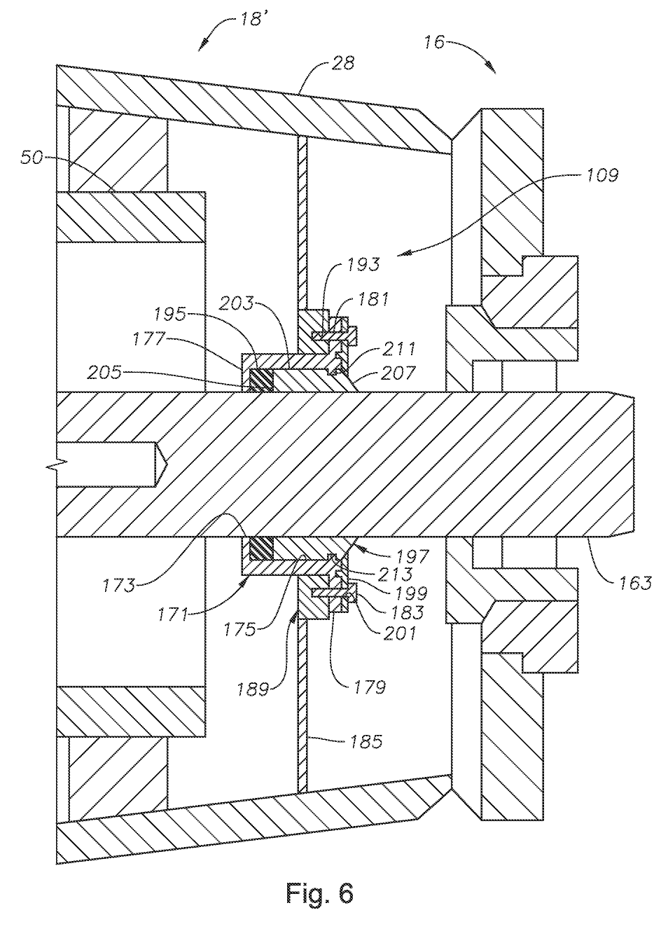

As shown in FIG. 6, the power seal assembly 109 includes a housing 171 having a first stage bore 173 extending therethrough and sized to receive the plunger 163, and a second stage bore 175 having a larger diameter, which together with the smaller bore 173, form an annular shoulder 177. The housing 171 also includes an annular flange 179 having a diameter greater than the diameter of the bore 175. The annular flange 179 includes a plurality of apertures or bolt holes 181 adapted to receive a corresponding plurality of bolts 183 or other fasteners. The sealed fluid end-facing side 185 of a power end 18′ of the pump 10′ includes an annular extension 189 extending from the power end 18′ of the pump 10′ toward the fluid end 16 of the pump 10′. The annular extension 189 includes a plurality of bolt holes or recesses 193 spaced apart to coaxially align with bolt holes 181 to receive bolts 183 to connect the annular flange 179 of the housing 171 to the fluid end-facing side 185 of power end 18′. Beneficially, annular extension 189 can be relatively thick in comparison to the thickness of fluid end facing side 185 of power end 18′ in order to reduce the amount of power seal assembly housing 171 extending into the power end 18′. This can allow for a reduction in the total length of power end 18′, and correspondingly can allow for an increase in the size of connector 105 and/or the total stroke of plunger 163.

A fluid seal 195, typically in the form of an O-ring, is positioned adjacent the annular shoulder 177 within the bore 175 to form a fluid seal between the inner diameter of housing 171 and the outer diameter of plunger 163.

The power seal assembly 109 also includes a splashguard assembly 197 having an annular retention plate 199 also having a plurality of bolt holes 201 adapted to receive bolts 183, and an elongate cylindrical section 203. The elongate cylindrical section 203 of the splashguard assembly 197 can have an inner diameter substantially matching the outer diameter of plunger 163 and an outer diameter substantially matching the inner diameter of bore 175. According to the illustrated configuration, the power end-facing face 205 of the cylindrical section 203 of the splashguard assembly 197 can have a substantially flat surface configured to land upon a substantially flat face of the fluid end-facing portion of seal 195. The fluid-end facing portion of a cylindrical section 203 of the splashguard 197, however, can have a tapered portion or extension forming a lip 207 which can enhance deflection of any fluids escaping the fluid end seal 72 (see FIGS. 4A-4B) of the fluid end 16.

The housing 171 can also include an inward facing annular stub 211 positioned adjacent the outward facing annular flange 179. The annular stub 211 is sized and positioned to help retain the cylindrical section 203 of the splashguard assembly 197. The cylindrical section 203 can correspondingly have an annular recess 213 having a smaller outer diameter than the outer diameter of the main body of the cylindrical section 203. In the illustrated configuration, the root of the lip 207 has a larger outer diameter such that the recess 213 forms a notch in the outer surface of the cylindrical section 203. When the annular flange 179 of the housing 171 and annular retention plate 199 of the splashguard assembly 197 are connected to the annular extension 189 of the fluid end-facing side 185 of the power end 18′, the annular stub 211 and the annular retention plate 199 urge the cylindrical section 203 in contact with the fluid seal 195, which in turn, urges the fluid seal 195 in contact with annular shoulder 177 to also/further enhance sealing.

The various embodiments and aspects described herein have several advantages such as improved performance and easier maintenance. The various design improvements also advantageously allow the bore 113 of crosshead 107 to be closer to the fluid-facing end 161. Such embodiments can advantageously further facilitate improvements in the design of the power seal assembly 109, which can provide sufficient sealing capability, even on plungers having a uniform or at least a substantially uniform outer diameter.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like, if or when used, are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A pump comprising:
a cylinder mounted in a pump housing and having a cylinder axis; and
a plunger assembly comprising a crosshead slidably disposed in the cylinder and comprising a bore extending laterally to the cylinder axis, a plunger comprising a power end section connected to the crosshead, a bushing having substantial portions fixedly mounted within the bore of the crosshead, and a wrist pin pivotally rotatably mounted within the bushing.

2. The pump as defined in claim 1, further comprising:
a crankshaft rotatably mounted in the housing, the crankshaft having a crankshaft axis; and
a connecting rod having a crankshaft end connected to the crankshaft and a crosshead end connected to the wrist pin, the wrist pin being pivotally rotatably mounted to the crosshead and fixedly connected to the crosshead end of the connecting rod to provide pivotal rotation when the connecting rod strokes.

3. The pump as defined in claim 1, wherein the crosshead end of the connecting rod comprises a flanged end comprising an arcuate portion having an inner surface radius that at least substantially matches an outer surface radius of the wrist pin.

4. The pump as defined in claim 3, wherein the arcuate portion of the flanged end extends from about 100 angle degrees to about 150 angle degrees.

5. The pump as defined in claim 3,
wherein the wristpin includes a set of fastener bores; and
wherein the flanged end comprises a set of fastener apertures and a set of fasteners extending therethrough and extending into a corresponding set of the fastener bores extending into the wrist pin to fixedly connect the crosshead end of the connecting rod to the wrist pin.

6. The pump as defined in claim 1, wherein the crosshead comprises an open slot portion extending from a crankshaft-facing end and along the longitudinal axis of the crosshead to join with the laterally-extending bore, and a crankshaft-facing recessed surface portion positioned at a base of the open slot portion, the pump further comprising:
a bushing assembly including the bushing and at least one retaining plate separate from or integral with the bushing, the retaining plate connected to the crankshaft-facing recessed surface portion to mount the bushing within the bore of the crosshead and to prevent rotation thereof.

7. The pump as defined in claim 6, wherein the crankshaft-facing surface portion is oriented at least substantially perpendicular to the longitudinal axis of the crosshead such that a surface plane of the crankshaft-facing recessed surface portion extends approximately through the center of the wrist pin when the wrist pin is positioned within the laterally-oriented bore.

8. The pump as defined in claim 1, wherein the bushing is in the form of a single arcuate-shaped bushing shaped to extend for at least approximately 180 angle degrees to conform to a corresponding outer surface portion of the wrist pin and a corresponding inner surface portion of the laterally-oriented bore of the crosshead.

9. The pump as defined in claim 1, further comprising:
a crankshaft having a crankshaft axis; and
a connecting rod having a crankshaft end connected to the crankshaft and a crosshead end connected to the wrist pin; wherein
the bushing is at least partially cylindrically shaped and extends circumferentially for an amount greater than 180 angle degrees to provide retention thereof and extends substantially less than 360 angle degrees to accommodate for pivotal rotation of the connecting rod resulting from rotation of the crankshaft end of the connecting rod about the crankshaft axis.

10. The pump as defined in claim 1, further comprising:
a power end having a sealed fluid end-facing side, the sealed fluid end-facing side having an aperture extending therethrough providing access to the crosshead; and
a power end seal assembly adjacent the aperture of the sealed fluid end-facing side and comprising a power end seal housing extending at least partially through the aperture and a power end seal positioned within the power end seal housing, the power end section of the plunger being in sealing contact with the power end seal.

11. The pump as defined in claim 10, wherein the power end seal is positioned within the power end seal housing at a location within confines of the power end.

12. The pump as defined in claim 10,
wherein the plunger further comprises a fluid end section extending through a fluid seal in an output manifold; and
wherein the power end seal assembly further comprises a splash guard positioned at least partially within the power end seal housing to deflect fluids escaping the output manifold through the fluid seal.

13. The pump as defined in claim 10, wherein the power end seal assembly further comprises a splashguard, the splash guard comprising an elongate cylindrical section positioned at least substantially within the power end seal housing to deflect fluids escaping an output manifold of the pump through an output manifold fluid seal.

14. The pump as defined in claim 13, wherein the power end facing surface of the elongate cylindrical section of the splash guard is positioned in contact with a corresponding fluid end facing surface of the power end seal.

15. The pump as defined in claim 14, wherein the cylindrical section of the splash guard is further positioned in contact with an inner surface of the power seal housing, an outer surface of the plunger, and a fluid end-facing face of the power end seal.

16. The pump as defined in claim 13, wherein the cylindrical section of the splash guard extends at least partially through the aperture of the sealed fluid end-facing side of the power end.

17. The pump as defined in claim 10, wherein the power end seal assembly further comprises a splashguard assembly, the splash guard assembly comprising a splashguard having an elongate cylindrical section, a conical shaped the lip section, and a bore extending therethrough.

18. The pump as defined in claim 1, further comprising:
a fluid end;
a power end having a sealed fluid end-facing side, the sealed fluid end-facing side having an aperture extending therethrough providing access to the crosshead, and an annular extension extending toward the fluid end; and
a power end seal assembly adjacent the aperture of the sealed fluid end-facing side and comprising a power end seal housing having an inwardly extending flange, an outwardly extending flange connected to the annular extension, and an elongate main body extending therebetween.

19. The pump as defined in claim 18, wherein the power end seal assembly further comprises:
an annular power end fluid seal positioned in contact with a fluid end-facing portion of the inward extending flange, an inner surface of the power seal housing, an outer surface of the plunger, and a power end-facing face of an elongate cylindrical section of a splash guard.

20. The pump as defined in claim 19, wherein the power end seal assembly further comprises a splashguard assembly, the splash guard assembly comprising the splashguard and an annular retention plate, the annular tension plate operable to urge the cylindrical section of the splashguard into contact with the power end seal which urges the power end seal into contact with the inwardly extending flange.

21. The pump as defined in claim 18, wherein the housing further comprises an inwardly extending annular stub located adjacent the outwardly extending flange.

22. The pump as defined in claim 21, wherein the power end seal assembly further comprises a splashguard assembly, the splash guard assembly comprising a splashguard, the splash guard comprising an elongate cylindrical section positioned at least substantially within the power end seal housing, the elongate cylindrical section including an annular recess aligned with the annular stub so that the annular stub functions to facilitate retaining the cylindrical section of the splashguard within the power end seal housing.

23. A pump having a power end, a fluid end, and a stroke length a stroke length, the pump comprising:
a housing comprising an entrance;
a cylinder mounted in the housing and having a cylinder axis;
a plunger assembly comprising a crosshead slidably disposed in the cylinder and comprising a bore extending laterally to the cylinder axis, a plunger comprising a power end section connected to the crosshead and a fluid end section extending through a fluid seal in an output manifold, a bushing having substantial portions fixedly mounted within the bore of the crosshead, and a wrist pin pivotally rotatably mounted within the bushing;
a crankshaft rotatably mounted in the housing, the crankshaft having a crankshaft axis;
a connecting rod having a crankshaft end connected to the crankshaft and a crosshead end connected to the wrist pin, the wrist pin being pivotally rotatably mounted to the crosshead and fixedly connected to the crosshead end of the connecting rod to provide pivotal rotation when the connecting rod strokes; and
a power end seal assembly adjacent the entrance to the cylinder, the power end section of the plunger being in sealing contact with a power end seal, the power end seal assembly comprising a power end seal housing, the power end seal, and a splash guard positioned at least partially within the power end seal housing to deflect fluids escaping the output manifold through the fluid seal.

24. A plunger assembly comprising:
a crosshead operable to be slidably disposed in a cylinder of a plunger pump, the crosshead comprising a bore extending laterally to a longitudinal axis of the cylinder;
a plunger comprising a fluid end section and a power end section connected to the crosshead;
a bushing having substantial portions fixedly mounted within the laterally extending bore of the crosshead; and
a wrist pin pivotally rotatably mounted within the bushing.

25. The plunger assembly as defined in claim 24, wherein the wrist pin includes a set of fastener recesses extending therein and positioned to receive a corresponding set of fasteners to fixedly connect a crosshead end of a connecting rod to the wrist pin.

26. The plunger assembly as defined in claim 24, wherein the crosshead comprises an open slot portion extending from a crankshaft-facing end along the longitudinal axis of the crosshead to join with the laterally-extending bore, and a crankshaft-facing recessed surface portion positioned at a base of the open slot portion, the plunger assembly further comprising:
a bushing assembly including the bushing and at least one retaining plate separate from or integral with the bushing, the retaining plate connected to the crankshaft-facing recessed surface portion to mount the bushing within the laterally extending bore of the crosshead and to prevent rotation thereof.

27. The plunger assembly as defined in claim 26, wherein the crankshaft-facing surface portion is oriented at least substantially perpendicular to the longitudinal axis of the crosshead such that a surface plane of the crankshaft-facing recessed surface portion extends approximately through the center of the wrist pin when the wrist pin is positioned within the laterally-oriented bore.

28. The plunger assembly as defined in claim 24, wherein the bushing is in the form of a single arcuate-shaped bushing that is shaped to extend for at least approximately 180 degrees to conform to a corresponding outer surface portion of the wrist pin and to conform to a corresponding inner surface portion of the laterally-oriented bore of the crosshead.

29. The plunger assembly as defined in claim 24, wherein the bushing is at least partially cylindrically shaped and extends circumferentially for an amount greater than 180 angle degrees to provide retention thereof and extends substantially less than 360 angle degrees to accommodate for pivotal rotation of a connecting rod when connected thereto resulting from rotation of a crankshaft end of the connecting rod about a crankshaft axis.
